(19) United States
(12) Patent Application Publication
(10) Pub. No.: US 2009/0310776 A1
(43) Pub. Date: Dec. 17, 2009

(54) INFORMATION CONCEALMENT METHOD AND INFORMATION CONCEALMENT DEVICE

(75) Inventor: Shigenaka Kanemitsu, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/397,838

(22) Filed: Mar. 4, 2009

(30) Foreign Application Priority Data
Jun. 13, 2008 (JP) 2008-154896

(51) Int. Cl. H04L 9/28

(52) U.S. Cl. 380/28; 706/47

(57) ABSTRACT

An information concealment method comprising: a splitting step to split information into an encryption segment to be encrypted and a non-encryption segment not to be encrypted according to a predetermined rule; an encryption step of encrypting the encryption segment; a control table generating step of generating a control table for indicating one of a location of the encryption segment and/or a location of the non-encryption segment of the information; and an organization step of coupling or associating the information, in which the encryption segment has been encrypted, with the control table and a device for performing the method are provided.

### INCORPORATION BY REFERENCE

This application is based upon and claims the benefit of priority from the corresponding Japanese Patent Application No. 2008-154896, filed Jun. 13, 2008, the entire contents of which is incorporated herein by reference.

### BACKGROUND

1. Field of the Invention

The present invention relates to an information concealment method and an information concealment device, which achieve concealment of information by encrypting the information according to a predetermined rule.

2. Description of the Related Art

At present, it is possible to perform updates, additions, and the like to the functionality of a computer device by installing software onto the computer device.

The software comprises information including a computer program and data. The information, comprising the software, is distributed from a producer/dealer to consumers in a state where the information is recorded in a recording medium such as an optical disk. Alternatively, the information comprising the software may be distributed as it is via a computer network such as the Internet.

In many cases, the information comprising the software to be distributed on the market is encrypted to achieve a concealment thereof. In order to prevent illegal copying or imitation, it is important to conceal the information comprising the software by encrypting the information before the software is distributed on the market.

The entirety of the information comprising the software which is distributed on the market is encrypted, which raises a problem that it takes a longer time to decrypt the software before installing the software onto a computer device. In other words, if the amount of information comprising the software is large, the size of the encrypted information is also large, and the amount of computation for decryption becomes large. As a result, it takes a long time to perform the decryption. In addition, before the software is distributed on the market, the entirety of the information comprising the software is encrypted, and hence the amount of computation for encryption becomes large, which leads to the problem that it takes a long time to perform the encryption.

### SUMMARY

Therefore, the present invention provides an information concealment method and an information concealment device, which are capable of reducing the amount of computation required for encryption or decryption of information such as that which constitutes software, to thereby improve operability or usability in performing the encryption or decryption of the information while ensuring concealment of the information.

To this end, the present invention provides an information concealment method, which achieves concealment of information by encrypting the information according to a predetermined rule, comprising:

a splitting step, during which the information is split into an encryption segment that is to be encrypted and a non-encryption segment that is not to be encrypted according to the predetermined rule;

an encryption step during which the encryption segment is encrypted;

a control table generating step during which a control table for indicating a location of the encryption segment and/or a location of the non-encryption segment of information is generated; and

an organization step during which the information, in which the encryption segment has been encrypted, is coupled or associated with the control table.

The present invention also provides an information concealment device comprising:

a split unit for splitting information into an encryption segment that is to be encrypted and a non-encryption segment that is not encrypted according to a predetermined rule;

an encryption unit for encrypting the encryption segment;

a control table generating unit for generating a control table that indicates the location of the encryption segment and/or the location of the non-encryption segment of the information; and

an organization unit for either coupling or associating the information, in which the encryption segment has been encrypted, with the control table.

Additional features and advantages are described herein, and will be apparent from the following Detailed Description and the figures.

### BRIEF DESCRIPTION OF THE FIGURES

In the accompanying drawings:

FIG. 1 is an explanatory diagram illustrating a product package including an installation package concealed by an information concealment method according to an embodiment of the present invention;

FIG. 2 is an explanatory diagram illustrating a control table included in the product package of FIG. 1;

FIG. 3 is a block diagram illustrating an information concealment device according to an embodiment of the present invention;

FIG. 4 is a flowchart illustrating a concealment processing performed by the information concealment device according to an embodiment of the present invention;

FIG. 5 is an explanatory diagram illustrating the installation package when a splitting step of the concealment process is being performed according to an embodiment of the present invention;

FIG. 6 is an explanatory diagram illustrating the installation package immediately after the splitting step of the concealment process is being performed according to an embodiment of the present invention;

FIG. 7 is an explanatory diagram illustrating the installation package immediately after the encryption step of the concealment process has been performed according to an embodiment of the present invention;

FIG. 8 is an explanatory diagram illustrating the installation package and other components immediately after the organization step of the concealment process has been performed according to an embodiment of the present invention;

FIG. 9 is an explanatory diagram illustrating the installation package immediately after the organization step of the concealment process has been performed by an information concealment device according to another embodiment of the present invention; and

FIG. 10 is an explanatory diagram illustrating the installation package immediately after the organization step of the concealment process has been performed by an information concealment device according to another embodiment of the present invention.

### DETAILED DESCRIPTION

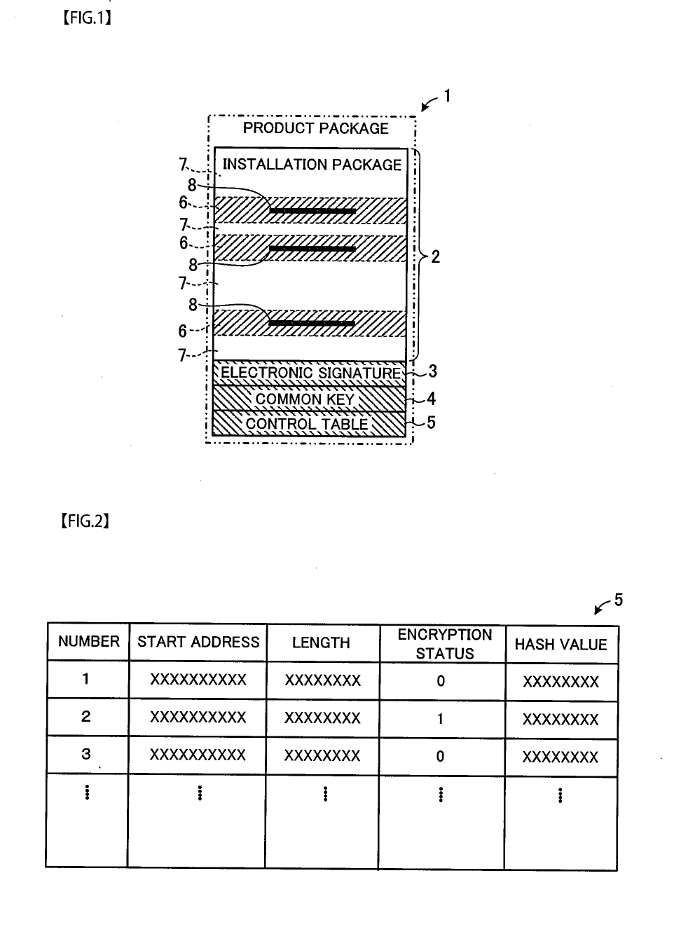

Hereinafter, an embodiment of the present invention will now be described. FIG. 1 illustrates a product package.

The product package 1 of FIG. 1 is a group of information generated by performing a concealment process on an installation package 2. The installation package 2 is distributed in the form of the product package 1.

The product package 1 includes the installation package 2, an electronic signature 3, a common key 4, and a control table 5.

The installation package 2, which is a specific example of information concealed by an information concealment method or an information concealment device according to the present invention, is subjected to the concealment process performed by an information concealment device 10 which is described hereinafter. The installation package 2 is obtained by packaging a computer program and data that comprise application software for changing, expanding, or updating the functionality of a computer device such as a personal computer and an installer therefor.

The installation package 2 is split into a plurality of segments. The segments each comprise an encryption segment 6 and a non-encryption segment 7. The encryption segment 6 is encrypted by a common key cryptosystem. The non-encryption segment 7 is not encrypted. Note that a bit pattern 8 existing within the encryption segment 6 is described hereinafter.

The electronic signature 3 is an electronic signature assigned by a producer or provider of application software in order to prove authenticity of the application software that is packaged in the installation package 2.

The common key 4 is a key used to encrypt the encryption segment 6 in the installation package 2.

As described later, the control table 5 is a table generated in the concealment process for concealing the installation package 2. Recorded in the control table 5 is control information necessary for performing a concealment canceling process that cancels the concealment of the concealed installation package 2 and restores the installation package 2 to the original state it was in before the concealment was performed.

In the product package 1, the electronic signature 3, the common key 4, and the control table 5 are encrypted by a public key cryptosystem. In addition, the product package 1 is subjected to a compression process in order to reduce the size thereof.

FIG. 2 illustrates the contents of the control table 5 included in the product package 1 of FIG. 1. Recorded in the control table 5 are the number, the start address, the length, the encryption status, and the hash value of each of the segments of the installation package 2. The “number” is, for example, a number assigned to each of the segments according to the order of the segments arranged from the beginning to the end of the installation package 2. The “start address” is the relative start address of each segment with reference to the start address of the installation package 2 and indicating one of the locations of the encryption segment 6 and the non-encryption segment 7 in the installation package 2. The “length” represents the length of each segment. The “encryption status” is, for example, a flag indicating the encryption status of each segment. The flag set to “0” indicates that the segment is not encrypted, that is, the segment is the non-encryption segment 7. On the other hand, the flag set to “1” indicates that the segment is encrypted, that is, the segment is the encryption segment 6. The “hash value” is the hash value of each segment. The “hash value” is a unique value according to the contents of each segment. The hash value is different even if the contents of a segment are only slightly different.

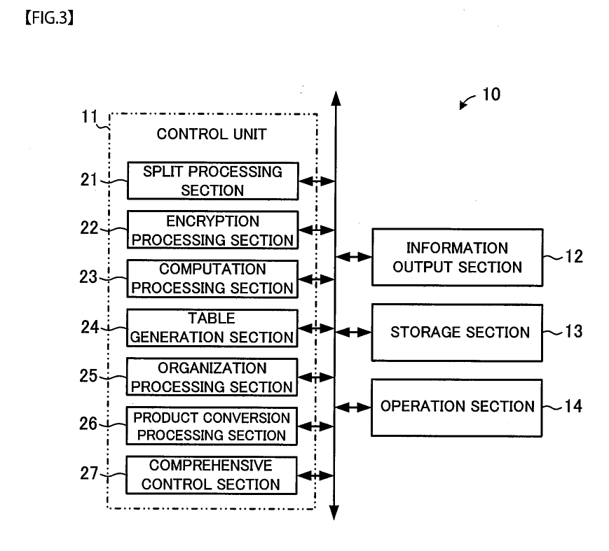

FIG. 3 illustrates the information concealment device. The information concealment device 10 of FIG. 3 represents an information concealment device according to an embodiment of the present invention, and performs the concealment process of the installation package 2. The information concealment device 10 is implemented by loading a concealment processing program on a personal computer.

The information concealment device 10 includes a control unit 11, an information output section 12, a storage section 13, and an operation section 14.

The control unit 11 includes a central processing unit (CPU) and a random access memory (RAM). The CPU reads the concealment processing program from the storage section 13 in order to cause the control unit 11 to function as a split processing section 21, an encryption processing section 22, a computation processing section 23, a table generation section 24, an organization processing section 25, a product conversion processing section 26, and a comprehensive control section 27, which are all described later. The CPU executes the concealment processing program to thereby cause the control unit 11 to function as the above-mentioned components 21 through 27. The RAM is used as a work memory by the CPU while it executes the concealment processing program.

The split processing section 21 splits the installation package 2 into the encryption segment 6 which is a segment to be encrypted, and the non-encryption segment 7 which is a segment that is not to be encrypted according to a predetermined split rule. The split processing section 21 is an example of a split unit.

The encryption processing section 22 uses the common key 4 to encrypt the encryption segment 6. The encryption processing section 22 is an example of an encryption unit.

The computation processing section 23 calculates the hash value of the encryption segment 6 and the hash value of the non-encryption segment 7. The computation processing section 23 is an example of a hash value calculating unit.

The table generation section 24 generates the control table 5. The table generation section 24 is an example of a control table generation unit.

The organization processing section 25 couples: the installation package 2 with the encryption segment 6 which has been encrypted; the electronic signature 3; the common key 4; and the control table 5. The organization processing section 25 is an example of an organization unit.

The product conversion processing section 26 encrypts the electronic signature 3, the common key 4, and the control table 5 by the public key cryptosystem, and performs the compression process on the entire product package 1.

The comprehensive control section 27 comprehensively controls the information concealment device 10.

The information output section 12 outputs the product package 1 generated by the concealment process to a storage medium. A configuration of the information output section 12 is determined based on the type of the recording medium to which the product package 1 is outputted. For example, if the recording medium to which the product package 1 is outputted is an optical disk, the information output section 12 is an optical disk drive.

The storage section 13 is, for example, a hard disk or a flash memory. The storage section 13 stores the above-mentioned concealment processing program. The concealment processing program includes an encryption program for encrypting the encryption segment 6 by the common key cryptosystem and a hash function for calculating the hash value of each segment of the installation package 2. In addition, the storage section 13 stores the installation package 2 that has not been subjected to the concealment process, the electronic signature 3, and the common key 4. Further, the storage section 13 stores a public key that is used for encrypting the electronic signature 3, the common key 4, and the control table 5 by the public key cryptosystem.

The operation section 14 is an input/output device for operating the information concealment device 10, such as a keyboard, a mouse, or a display.

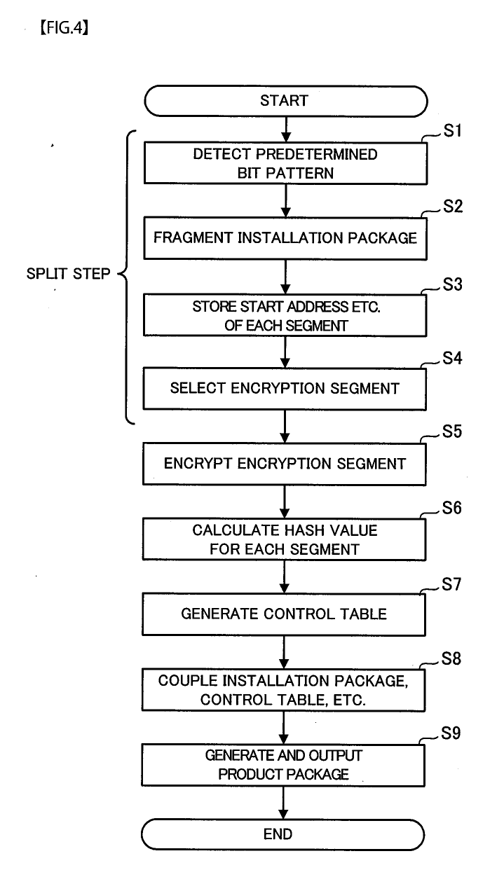

FIG. 4 illustrates the concealment process performed by the information concealment device 10. The concealment process is a process for achieving concealment of the installation package 2. At a point in time before the concealment process is started, the storage section 13 of the information concealment device 10 stores the installation package 2 that is to be subjected to the concealment process. When an operator, who is working on the concealment process, operates the operation section 14 of the information concealment device 10 to input an instruction to start the concealment process to the information concealment device 10, the concealment process begins with respect to the installation package 2.

As illustrated in FIG. 4, in the concealment process, the split processing section 21 first splits the installation package 2 into the encryption segment 6 to be encrypted and the non-encryption segment 7 not to be encrypted according to the predetermined split rule (splitting step). The split rule used in an embodiment is that a part of the installation package 2 incorporating a predetermined bit pattern and having a predetermined size is set as the encryption segment 6.

The splitting step comprises 4 steps: Steps S1 through S4. First, as illustrated in FIG. 5, the split processing section 21 detects a predetermined bit pattern 8 from within the installation package 2 (Step S1). Examples of the predetermined bit pattern 8 include a bit pattern indicating an information bit that greatly needs to be concealed for protection, a bit pattern indicating a part of a program whose imitation is disabled by being encrypted, and a bit pattern indicating a name of a creator of the program.

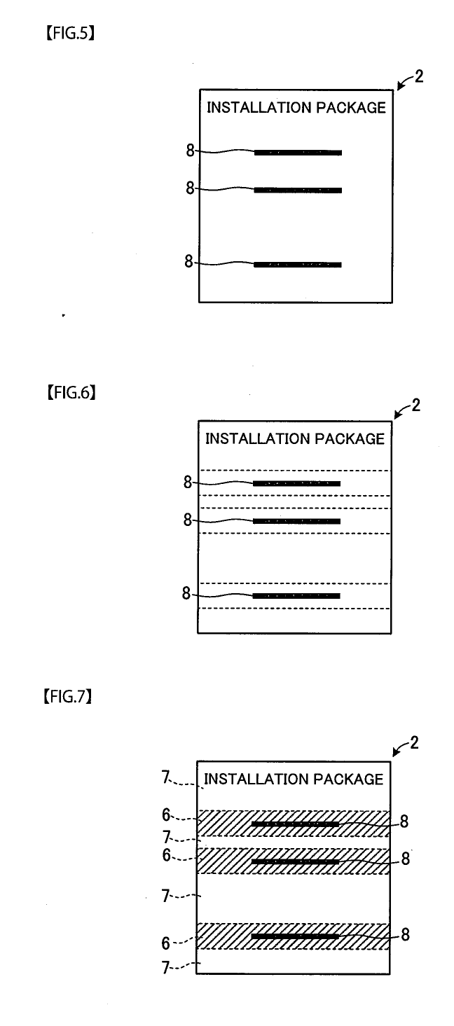

Subsequently, as illustrated in FIG. 6, the split processing section 21 fragments the installation package 2 into a plurality of segments located where the predetermined bit pattern 8 has been detected as a reference (Step S2). Thus, the split processing section 21 selects, as 1 segment, a cluster of information constituted by the predetermined bit pattern 8, an information bit immediately before the bit pattern 8 having a size of, for example, 100 bytes, and an information bit immediately after the bit pattern 8 having a size of, for example, 100 bytes. Note that if the length from immediately before the predetermined bit pattern to the start of the installation package 2 is less than 100 bytes, the split processing section 21 selects an information bit spanning from the start of the installation package 2 to immediately before the predetermined bit pattern as the part on the start side of the encryption segment 6. If the length from immediately after the predetermined bit pattern to the end of the installation package 2 is less than 100 bytes, the split processing section 21 selects an information bit spanning from immediately after the predetermined bit pattern to the end of the installation package 2 as the part on the end side of the encryption segment 6. The length of each of the information bits before and after the predetermined bit pattern is not necessarily 100 bytes. If there are a plurality of bit patterns 8 within the installation package 2, the split processing section 21 selects a plurality of such segments. In addition, the split processing section 21 selects each of remaining parts of the installation package 2 separated by the selected segments as another segment.

Subsequently, the split processing section 21 assigns a number to each of the segments in the order from the beginning of the installation package 2 to the end of the installation package 2. The split processing section 21 then examines the relative start address (value of the location of the encryption segment 6 or the location of the non-encryption segment 7 in the installation package 2) of each segment with reference to the start address of the installation package 2 to find the length of each segment. Then, the split processing section 21 temporarily stores the number, the start address, and the length of each of those segments in the RAM or the storage section 13 of the control unit 11 (Step S3).

The split processing section 21 then selects the segment including the predetermined bit pattern 8 as the encryption segment 6 (Step S4). The split processing section 21 sets the flag indicating the encryption status to “1” with respect to the segment selected as the encryption segment 6. The split processing section 21 sets the flag indicating the encryption status to “0” with respect to the non-encryption segment 7. Those values of the flag are temporarily stored in the RAM or the storage section 13 of the control unit 11.

Subsequently, as illustrated in FIG. 7, the encryption processing section 22 uses the common key 4 stored in the storage section 13 to encrypt the encryption segment 6 via the common key cryptosystem (Step S5: encryption step).

The computation processing section 23 then calculates the hash value of each segment of the installation package 2 (Step S6: hash value calculating step). Each of the calculated hash values is temporarily stored in the RAM or the storage section 13 of the control unit 11.

The table generation section 24 then generates the control table 5 by reading and arranging the number, the start address, the length, the flag of the encryption status, and the hash value of each segment, which are temporarily stored in the RAM or the storage section 13 of the control unit 11 (Step S7: control table generating step).

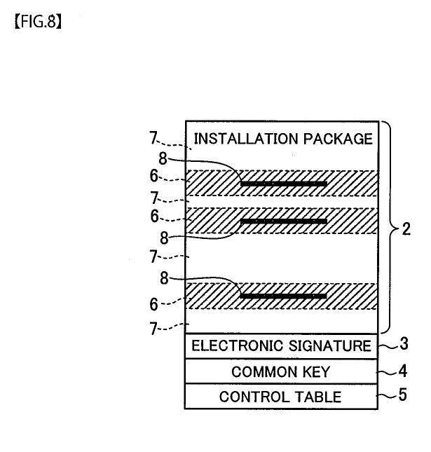

As illustrated in FIG. 8, the organization processing section 25 then couples: the installation package 2 with the encryption segment 6 having been encrypted; the control table 5; and the electronic signature 3 and the common key 4 that are stored in the storage section 13 (Step S8: organization step).

Subsequently, the product conversion processing section 26 generates the product package 1 by encrypting the electronic signature 3, the common key 4, and the control table 5 by the public key cryptosystem. The product conversion processing section 26 performs a compression processing on the entire product package 1. The compressed product package 1 is then outputted to the recording medium such as an optical disk through the information output section 12 (Step S9: product conversion step).

The recording medium in which the product package 1 is recorded is distributed on the market as a product related to the installation package 2. A consumer who purchases the product from the market instructs the computer device to install the application software of the installation package 2. The CPU of the computer device extracts (decompresses) the product package 1, and decrypts the electronic signature 3, the common key 4, and the control table 5. Then, the CPU of the computer device uses the common key 4 and the control table 5 that have been decrypted to decrypt the encryption segment 6 of the installation package 2 (concealment canceling process). That is, in the concealment canceling process, the CPU of the computer device first identifies each segment of the installation package 2 based on the start address and the length of each segment of the installation package 2 recorded in the control table 5, identifies each of the encryption segments 6 based on the flag indicating the encryption status, and uses the common key 4 to decrypt each of the encryption segments 6.

As described above, according to the concealment process performed by the information concealment device 10, only the encryption segments 6 that are parts of the installation package 2 are encrypted, and hence the amount of computation for encryption is less than in the case where the entirety of the installation package 2 is encrypted. Therefore, the concealment of the installation package 2 is performed in a shorter period of time. Further, when a user of the computer device installs the application software onto the computer device, the computer may only have to perform a decrypting process on the encryption segment 6. This reduces the number of computations required for decryption. Therefore, the computer device can install the application software related to the installation package 2 onto the computer device in a short period of time. Further, during the concealment process performed by the information concealment device 10, the bit pattern indicating an information bit that greatly needs to be concealed for protection, the bit pattern indicating a part of a program whose imitation is disabled by being encrypted, or the like is detected, and only the segment including such a bit pattern is encrypted. Therefore, the efficient concealment of the installation package 2 is ensured. As described above, according to the concealment process performed by the information concealment device 10, the concealment of the installation package 2 is ensured and efficient, and operability and usability in performing the encryption or decryption of the installation package 2 are great.

Further, the installation package 2 concealed by the concealment process performed by the information concealment device 10 is split into a plurality of segments, and the encryption is performed on each of the encryption segments 6 on an individual encryption segment 6 basis. Therefore, even after the concealment process is performed on the installation package 2, information is changed or updated only by replacing a segment that needs to be changed or updated with a new segment. That is, regarding the installation package 2 concealed by the concealment process that is performed by the information concealment device 10, it is easy to partially change or update the installation package 2 even after the concealment of the installation package 2 is performed.

Further, according to the concealment process performed by the information concealment device 10, the non-encryption segment 7 in the installation package 2 is not encrypted. Therefore, it is extremely easy to change or update the information bit included in the non-encryption segment 7. That is, there is no need to decrypt a segment for the change or the update, and there is no need to encrypt the segment after the change or the update. In addition, it is possible to directly rewrite only a small partial information bit within the segment into another information bit. Therefore, after the concealment of the installation package 2 is performed, it is easy to partially change or update the installation package 2.

Unencrypted information generally exhibits a higher compression ratio than encrypted information. In the concealment process performed by the information concealment device 10, the non-encryption segment 7 in the installation package 2 is not encrypted. The installation package 2 exhibits a higher compression ratio in the product conversion step than in the case where the entirety of the installation package 2 is encrypted, and hence the creator of the installation package 2 can reduce the size of the product package 1.

In the concealment process performed by the information concealment device 10, the hash value of each segment of the installation package 2 is recorded in the control table 5. Therefore, the user can compare the hash value of each segment of the installation package 2 before the change or update with the hash value of each segment of the installation package 2 after the change or update, respectively, to thereby determine a difference therebetween on a segment by segment basis with ease. For example, when an old version of a computer program which has already been installed in the computer device is to be updated to a new version of a computer program, the user compares the hash value of each segment of the installation package 2 including the old version of the computer program with the hash value of each segment of the installation package 2 including the new version of the computer program, and identifies a segment having a different hash value therebetween. Then, the user causes only the identified segment to be read by the computer device or to be transmitted by the computer device via the computer network such as the Internet. After that, the user executes the process of installing only the identified segment that has been read or received onto the computer device to update the old version of the computer program to the new version of the computer program. Accordingly, the user can more efficiently and quickly update a program.

In an information concealment device according to another embodiment of the present invention, in the splitting step of the concealment process, the split processing section 21 splits the installation package 2 into the encryption segment 6 and the non-encryption segment 7 according to a split rule different from the above-mentioned split rule used in the previous embodiment. The split rule used in this embodiment is that a part of the installation package 2 including an application program interface (API) call instruction and having a predetermined size is set as the encryption segment 6.

In the splitting step, the split processing section 21 first detects the API call instruction from within the installation package 2.

Subsequently, the split processing section 21 fragments the installation package 2 into a plurality of segments with a location where the API call instruction has been detected as a reference. In other words, the split processing section 21 selects, as one segment, a cluster of information comprising the API call instruction, an information bit immediately before the API call instruction having a size of, for example, 100 bytes, and an information bit immediately after the API call instruction having a size of, for example, 100 bytes. If there are a plurality of API call instructions within the installation package 2, the split processing section 21 selects a plurality of such segments. In addition, the split processing section 21 selects each of remaining parts of the installation package 2 separated by the selected segments, as another segment.

The split processing section 21 then assigns a number to each of the segments, examines the start address and the length of each segment, and temporarily stores the numbers, the start addresses, and the lengths of those segments in the RAM or the storage section 13 of the control unit 11.

The split processing section 21 then selects the segment including the API call instruction as the encryption segment 6. The split processing section 21 sets the flag indicating the encryption status to “1” with respect to the segment selected as the encryption segment 6, and sets the flag indicating the encryption status to “0” with respect to the remaining segment, that is, the non-encryption segment 7. After that, the split processing section 21 temporarily stores those values of the flag in the RAM or the storage section 13 of the control unit 11.

Then the encryption processing section 22 uses the common key 4 stored in the storage section 13 to encrypt the encryption segment 6 by the common key cryptosystem.

Subsequently, the compressed product package 1 is generated by the same process as the above-mentioned process corresponding to Steps S6 through S9 of the concealment process according to the previous embodiment.

This embodiment of the present invention can also produce substantially the same effects as the previous embodiment. In particular, by encrypting the segment including the API call instruction, the manufacturer of the installation package 2 can efficiently prevent illegal copy or imitation of the computer program included in the installation package 2.

In an information concealment device according to a still further embodiment of the present invention, in the splitting step of the concealment process, the split processing section 21 splits the installation package 2 into the encryption segment 6 and the non-encryption segment 7 according to a split rule different from the above-mentioned split rule used in the previous embodiments. The split rule used in this embodiment is that the installation package 2 is split into a plurality of segments having a fixed length, and some segments are randomly selected from among the plurality of segments to be set as the encryption segments 6. The fixed length of each segment is, for example, several hundred bytes. Alternatively, the fixed length of each segment may be set to be, for example, 1/100 of the length of the installation package 2.

In the splitting step, the split processing section 21 first splits the installation package 2 into a plurality of segments having a fixed length.

Subsequently, the split processing section 21 randomly selects some segments from among the plurality of split segments, and sets those selected segments as the encryption segments 6. Then, the split processing section 21 selects the remaining segments of the plurality of split segments as the non-encryption segments 7. The operator who is working on the concealment process selects a percentage of the total number of the segments formed by splitting the installation package 2 as the encryption segments 6 arbitrarily depending on the degree of concealment of the installation package is required.

The split processing section 21 then assigns a number to each of the segments of the installation package 2, calculates the start address of each segment, sets the flag indicating the encryption status with respect to each segment, and stores the number, the start address, the length, and the flag indicating the encryption status of each of those segments in the RAM or the storage section 13 of the control unit 11.

Subsequently, as illustrated in FIG. 9, the encryption processing section 22 uses the common key 4 stored in the storage section 13 to encrypt the encryption segment 6 by the common key cryptosystem.

The compressed product package 1 is then generated by the same process as the above-mentioned process corresponding to Steps S6 through S9 of the concealment process according to the previous embodiment.

This embodiment of the present invention can also produce substantially the same effects as the previous embodiments. In particular, since the installation package 2 is split into segments having a fixed length, the process of the splitting step becomes simple. Accordingly, it is possible to reduce the time required for the concealment process, and reduce process loads on the information concealment device 10.

In an information concealment device according to another embodiment of the present invention, in the splitting step of the concealment process, the split process section 21 splits the installation package 2 into the encryption segment 6 and the non-encryption segment 7 according to a split rule different from the previous split rules used in the previous embodiments. The split rule used in this embodiment is that the installation package 2 is split into a plurality of segments each having a random length, and some segments are randomly selected from among the plurality of segments to be set as the encryption segments 6.

In the splitting step, the split processing section 21 first splits the installation package 2 into a plurality of segments each having a random length.

The split processing section 21 then assigns a number to each of the split segments in the order from the beginning of the installation package 2 to the end of the installation package 2. The split processing section 21 selects segments assigned an even number from among those segments as the encryption segment 6, and selects segments assigned an odd number as the non-encryption segment 7.

Subsequently, the split processing section 21 examines the start address and the length of each segment of the installation package 2, sets the flag indicating the encryption status with respect to each segment, and stores the number, the start address, the length, and the flag indicating the encryption status of each segment in the RAM or the storage section 13 of the control unit 11.

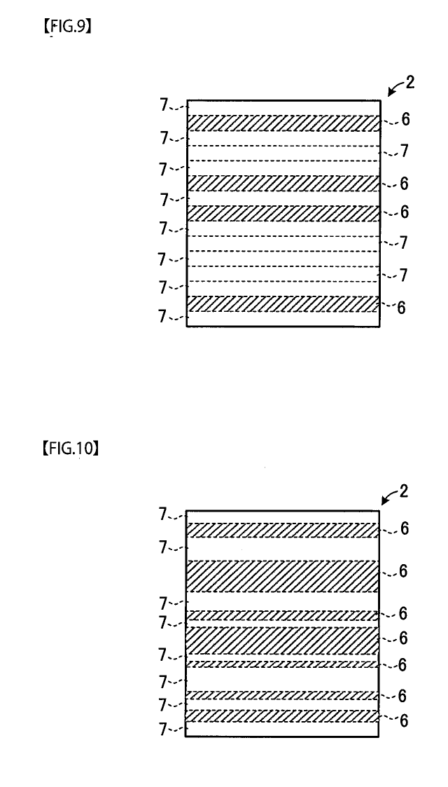

As illustrated in FIG. 10, the encryption process section 22 then uses the common key 4 stored in the storage section 13 to encrypt the encryption segment 6 by the common key cryptosystem.

The compressed product package 1 is generated by the same process as the above-mentioned process corresponding to Steps S6 through S9 of the concealment process according to the previous embodiment.

This embodiment of the present invention can also produce substantially the same effects as the above-mentioned previous embodiments. In particular, the installation package 2 is split into segments each having a random length, some of which are encrypted, and hence the installation package 2 is robustly concealed. For example, even if a third party attempts to decrypt the encryption segment 6 of the installation package 2, it is difficult to determine where the encryption segment 6 is located within the installation package 2.

Note that in the above-mentioned embodiment, the encryption of the segment including the predetermined bit pattern 8 is described as an example, but the present invention is not limited thereto. The encryption processing section 22 may encrypt a segment including a predetermined text pattern.

In each of the above-mentioned embodiments, the organization processing section 25 is coupled with the installation package 2, the electronic signature 3, the common key 4, and the control table 5 in the organization step of the concealment process, but the present invention is not limited thereto. For example, the organization processing section 25 may alternately generate a first product package including the installation package 2, the electronic signature 3, and the common key 4 and a second product package including the control table 5, and may assign identification information for distinguishing one product package from another product package to thereby associate the first product package and the second product package with each other.

Further, in the present invention, it is possible to use a split rule different from the split rule used in any of the above-mentioned embodiments. For example, in a case where a plurality of computer programs are included in the installation package 2, the split processing section 21 may split the installation package 2 into a plurality of segments so that the computer programs correspond to the segments on a one-to-one basis, and decide whether or not to encrypt each of the segments depending on whether or not it is necessary to protect each of the computer programs.

In each of the above-mentioned embodiments, the computation processing section 23 calculates the hash value of each segment, and the table generation section 24 records the hash value into the control table 5, but the present invention is not limited thereto. The computation processing section 23 may skip the computation of the hash value with respect to some segments. For example, in a situation where a part of the program or the data or a numerical value therefor needs to be changed after the concealment processing is performed on the installation package 2, the calculation and recording of the hash value are not performed with respect to the segment including an information bit that needs to be changed. Therefore, it is extremely easy to change such an information bit; after changing the information bit, there is no need to perform a recalculation and recording of the hash value of the corresponding segment.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information concealment method, comprising:
a splitting step to split information into an encryption segment to be encrypted and a non-encryption segment not to be encrypted according to a predetermined rule;
an encryption step of encrypting the encryption segment;
a control table generating step for generating a control table for indicating a location of the encryption segment and/or a location of the non-encryption segment of the information; and
an organization step to couple or associate the information, in which the encryption segment has been encrypted, with the control table.

2. The information concealment method according to claim 1, wherein the splitting step comprises setting a segment including one of a predetermined bit pattern and a predetermined text pattern as the encryption segment within the information.

3. The information concealment method according to claim 1, wherein the splitting step comprises setting a segment including an application program interface (API) call instruction as the encryption segment within the information.

4. The information concealment method according to claim 1, wherein the splitting step comprises:
splitting the information into a plurality of segments having a fixed length;
selecting some segments from among the plurality of segments; and
setting the selected some segments as encryption segments.

5. The information concealment method according to claim 1, wherein the splitting step comprises:
splitting the information into a plurality of segments each having a random length;
selecting some segments from among the plurality of segments; and
setting the selected some segments as encryption segments.

6. The information concealment method according to claim 1, comprising a hash value calculating step of calculating one of a hash value selected from the group consisting of the encryption segment and the non-encryption segment,
wherein the control table generating step comprises recording the hash value calculated in the hash value calculating step into the control table.

7. The information concealment method according to claim 6, wherein the hash value calculating step comprises calculating at least a hash value of a part of the encryption and non-encryption segments.

8. The information concealment method according to claim 1, wherein the splitting step comprises splitting, in a case where a plurality of programs are included in the information, the information into a plurality of segments so that the plurality of programs correspond to the plurality of segments on a one-to-one basis.

9. The information concealment method according to claim 1, wherein the control table generating step comprises recording at least a start address, a length, and a value indicating an encryption status of each segment into the control table.

10. An information concealment device, comprising:
a split unit for splitting information into an encryption segment to be encrypted and a non-encryption segment not to be encrypted according to a predetermined rule;
an encryption unit for encrypting the encryption segment;
a control table generating unit for generating a control table for indicating a location of the encryption segment and/or a location of the non-encryption segment of the information; and
an organization unit to couple or associate the information, in which the encryption segment has been encrypted, with the control table.

11. The information concealment device according to claim 10, wherein the split unit sets a segment including one of a predetermined bit pattern and a predetermined text pattern as the encryption segment within the information.

12. The information concealment device according to claim 10, wherein the split unit sets a segment including an application program interface (API) call instruction as the encryption segment within the information.

13. The information concealment device according to claim 10, wherein the split unit splits the information into a plurality of segments having a fixed length, selects some segments from among the plurality of segments, and sets the selected some segments as encryption segments.

14. The information concealment device according to claim 10, wherein the split unit splits the information into a plurality of segments each having a random length, selects some segments from among the plurality of segments, and sets the selected some segments as encryption segments.

15. The information concealment device according to claim 10, comprising a hash value calculating unit for calculating a hash value selected from the group consisting of the encryption segment and the non-encryption segment,
wherein the control table generating unit records the hash value calculated by the hash value calculating unit into the control table.

16. The information concealment device according to claim 15, wherein the hash value calculating unit calculates at least a hash value of a part of the encryption and non-encryption segments.

17. The information concealment device according to claim 10, wherein the split unit splits, in a case where a plurality of programs are included in the information, the information into a plurality of segments so that the plurality of programs correspond to the plurality of segments on a one-to-one basis.

18. The information concealment device according to claim 10, wherein the control table generating unit records at least a start address, a length, and a value indicating an encryption status of each segment into the control table.

19. An information concealment method, comprising:
a splitting step for moving information into an encryption segment and a non-encryption segment according to a predetermined rule;
an encryption step of encrypting the encryption segment;
a step for generating a control table for indicating a location of the encryption segment on the information; and
a step to couple the information, in which the encryption segment has been encrypted, with the control table.
